(19) United States
(12) Patent Application Publication
(10) Pub. No.: US 2008/0119117 A1
(43) Pub. Date: May 22, 2008

(54) BRAKE ROTOR DEGLAZING TOOL

(76) Inventor: Robert William Nichols, Dallas, TX (US)

Correspondence Address: CARSTENS & CAHOON, LLP, P O BOX 802334, DALLAS, TX, 75380, US

(21) Appl. No.: 11/850,473

(22) Filed: Sep. 5, 2007

Related U.S. Application Data
(60) Provisional application No. 60/861,366, filed on Nov. 21, 2006.

(51) Int. Cl. B24B 7/17; F16D 65/12

(52) U.S. Cl. 451/63; 188/218 XL

(57) ABSTRACT

A deglazing tool for use on motorcycle and ATV disc brake rotors. The tool is handheld and has abrasive pads that engage the rotor braking surface. The abrasive pads cut through the glaze on the braking surface of the rotor. Grip pressure on the handles maintains pad engagement with the rotor to assist the deglazing action. Compression springs below the deglazing heads or between the handles may be utilized to control the pressure between the rotor and pad. The surface glaze is removed and the surface is “roughened-up” and restored to the desired surface finish to improve overall braking performance and feel. The tool can be used with the rotor and brake caliper in place.

### CROSS-REFERENCE TO RELATED APPLICATIONS

This application claims the benefit of provisional Application No. 60/861,366, filed Nov. 21, 2006.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to handheld automotive tools. More specifically, the present invention relates to a handheld tool for deglazing the disc brake rotor on a motorcycle or ATV.

2. Description of Related Art Including Information Disclosed Under 37 CFR 1.97 and 1.98

Most modern motorcycles and ATVs have reasonably good brakes when they are new. However, as the braking system ages through use, braking performance deteriorates markedly. This occurs not only because of wear of the friction pads, but wear of the rotor surface itself.

When the vehicle is shipped from the factory, the braking system is typically in its optimum condition. This means that the rotor surfaces are clean and flat and have the most favorable surface finish. Also, the braking surface of the friction pads is clean and flat as well. Thus, when the pads contact the rotor, there is maximum surface contact between the component parts. This yields the best overall braking feel and performance due to maximum surface friction and heat transfer.

With normal use of the brakes, deterioration eventually shows up in the form of visible grooves and patterns in the brake rotor friction surface. This occurs because of heat buildup in the center of the friction pads when the brakes are applied.

Heat concentrates at the center of the pads because the pads are always in contact with the rotor even when the brakes are not applied. This minimal friction tends to maintain heat in the pad surface. Air flowing over the exposed outer edges of the pads cools this region. Thus, a temperature gradient forms over the pad surface.

This uneven temperature distribution causes the brake rotor friction surface to wear unevenly. The result is typically a concave wear pattern with uneven ridges on both sides of the rotor. If new pads (having a flat friction surface) are installed without resurfacing the rotor, the pads will ride on the edges and high spots of the worn rotor surface. This causes excessive heat in these spots due to the reduced braking surface area. This excessive heat is transferred through the brake piston and to the brake fluid, causing poor brake feel or outright braking system failure.

To prevent these problems, the brake rotor should be replaced or resurfaced when changing pads. Replacing the brake rotor can be quite costly and unnecessary. As long as the rotor thickness is within specification, it can be resurfaced to return it to square with the proper finish. However, this still requires removal of the wheel and rotor to accomplish the refinishing, which can be time consuming and costly as well.

Motorcycle and ATV riders in active competition require precise brake feel and performance. However, the brake system is subjected to extreme temperature due to the stresses of racing. In addition to normal wear, these temperatures cause friction pads and rotor surfaces to develop a hard glaze causing the brakes to squeal when applied. Braking performance deteriorates when the brakes become glazed and worn. Traditionally, removal of the glaze was accomplished by resurfacing the rotors and replacing the pads as mentioned previously. However, during a racing event there may be precious little time to remove the wheel to perform a traditional rotor resurfacing.

Accordingly, a need exists for an apparatus and method for resurfacing both friction surfaces of a motorcycle or ATV disc brake rotor that does not require removal of the rotor from the vehicle. Further, a need exists for an apparatus and method for resurfacing such disc brake rotors that is relatively inexpensive, rapid, simple, and efficient to use. The present invention meets these needs and others as will be demonstrated by the accompanying disclosure.

### BRIEF SUMMARY OF THE INVENTION

The apparatus of the present invention allows a user to resurface both sides of a motorcycle or ATV disc brake rotor without removal of the disc brake caliper or rotor from the vehicle. The apparatus is a handheld tool with two levers hinged in a fashion similar to a pair of pliers.

Each lever of the tool features a jaw end, a fulcrum hole, and a handle. Both levers are joined at the fulcrum hole by a fulcrum bolt, creating a pivot point about which both levers rotate. The fulcrum bolt positively retains both levers while allowing each to rotate relative to the other. As the handles are squeezed together, the levers rotate such that the jaw ends close together. In another embodiment, as the handles are squeezed together the jaws ends open. In this embodiment, spring pressure may be utilized to force the jaws closed.

Each jaw of the apparatus features an attachment point for an abrasive pad. Each pad is rigidly attached to a pad holder (i.e., in combination, the “deglazing head”), which is subsequently attached to the jaw end of the apparatus. The pad holder, while positively retained, is attached such that it floats relative to the plane of the jaw. Another embodiment features a compression spring between the pad holder and the jaw.

In combination, the two abrasive pads of the tool engage with the disc brake rotor friction surface. The handles are moved to open the jaws and the tool is placed over the disc rotor. The tool is positioned such that each pad engages one rotor friction surface. With sufficient pressure applied and maintained on both handles, the rotor is deglazed by rotating the wheel by hand. Several rotations are necessary to sufficiently deglaze the rotor and restore proper braking action and feel.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, in which like reference numbers refer to like parts throughout the views, wherein:

FIG. 1 is a side view of a preferred embodiment of the apparatus of the present invention;

FIG. 2 is a top view of a first lever of the embodiment with the lever depicted as pre-bent;

FIG. 3 is a side view of a first lever of the embodiment with the lever depicted as pre-bent;

FIG. 4 is a side view of a first lever of the embodiment with the lever depicted in its final bent configuration;

FIG. 5 is a top view of a second lever of the embodiment with the lever depicted as pre-bent;

FIG. 6 is a side view of a second lever of the embodiment with the lever depicted as pre-bent;

FIG. 7 is a side view of a second lever of the embodiment with the lever depicted in its final bent configuration;

FIG. 8 is a side view of the fulcrum bolt of the embodiment;

FIG. 9 is an exploded view of the components of the stone holder of the embodiment;

FIG. 10 is a view of the size and shape of the aluminum oxide abrasive stone as used in the embodiment;

FIG. 11 is an exploded view of the stone holder and a stone; and

FIG. 12 is an assembled view of the stone holder and stone configured as a deglazing head for the embodiment.

Where used in the various figures of the drawing, the same reference numbers designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood (58,266).

### DETAILED DESCRIPTION OF THE INVENTION

ATV, as defined with the present invention, includes all-terrain vehicles powered by a motor (electrical, combustion, or a combination of the two), by the rider (such as a mountain bike), or by the wind. The use of this invention merely dictates that the vehicle features disc brakes having a brake rotor with friction surfaces that are accessible.

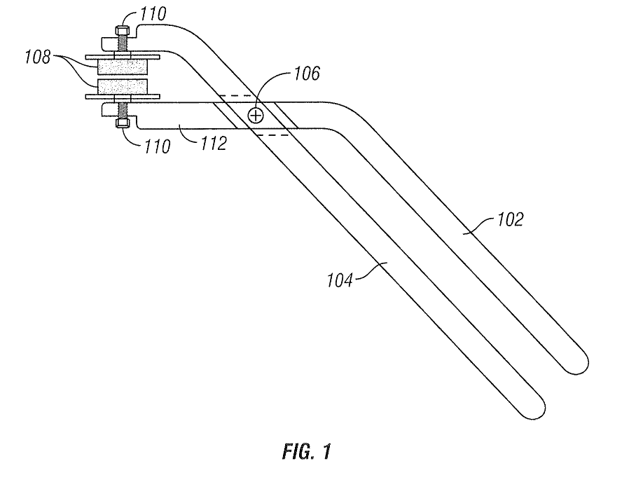

FIG. 1 depicts a preferred embodiment of the handheld brake deglazing apparatus of the present invention. The apparatus comprises two handles (102 and 104) hinged by a fulcrum bolt (106) such that the two opposing jaws (112) move inward towards one another when the handles (102 and 104) are squeezed together. The jaws (112) comprise deglazing heads (110) that float relative to the plane of the jaw to which each is attached.

The apparatus is designed to be operated using pressure applied by the palm of one of the user's hands to both handles (102 and 104). Consequently, the material chosen must be able to resist significant deflection when force is applied. In this embodiment, approximately 0.5000 inch aluminum bar stock was utilized for the handles (102 and 104). Although the preferred embodiment utilizes aluminum, other materials such as steel or plastic may be utilized as well.

The abrasive material (108) for the deglazing head (110) in this embodiment is aluminum oxide. However, one skilled in the arts will appreciate that other equivalent abrasive materials may be chosen without straying from the inventive concept. For example, the abrasive material may be silicon carbide, boron carbide, carbon (i.e., diamond), or the like. This embodiment features aluminum oxide due to its ready availability, all around effectiveness, and minimal expense.

Different abrasive grit values can be utilized depending on the desired results. For example, an aluminum oxide grit of approximately 30 is preferred when deglazing a standard rotor that is in poor condition, such as with excessive wear or glaze. This aggressive grit will more readily cut through the rotor surface to remove the debris and smooth some of the high spots on the friction surface. This grit tends to crumble when used which serves to maintain the abrasive materials sharpness. This sharpness allows the tool to cut through hard-baked and heavily glazed rotor surfaces.

If the rotor is deglazed frequently such that its braking surface is not excessively glazed or worn, then a less aggressive 80 grit or higher may be utilized. This grit is sufficient to remove the debris and glaze without removing too much of the actual rotor material. Such grit is also very effective in maintaining the rotor surface to prevent excessive glazing or wear. Silicon carbide may also be utilized with similar effectiveness for the abrasive material, in grit numbers similar to those of aluminum oxide.

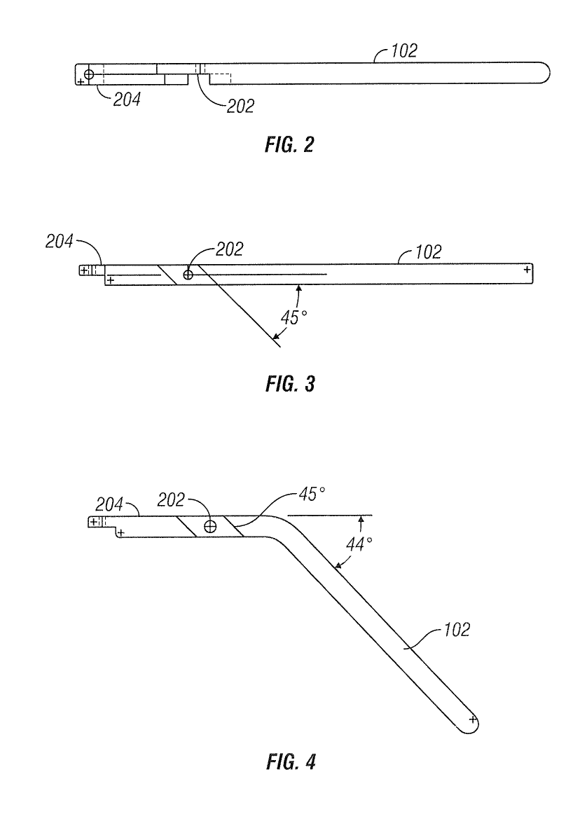

FIG. 2 through FIG. 4 depict the construction of the first handle (102). The first handle in this embodiment is machined from a single piece of bar stock. However, one skilled in the art will appreciate that the material may also be in multiple pieces that are joined by a means that will resist separation under stress, such as by welding.

The first handle (102) is machine cut at the jaw (204) and the fulcrum point (202). Following the machine cuts, the handle is bent to approximately 44 degrees, approximately 4 to 5 inches from the jaw end.

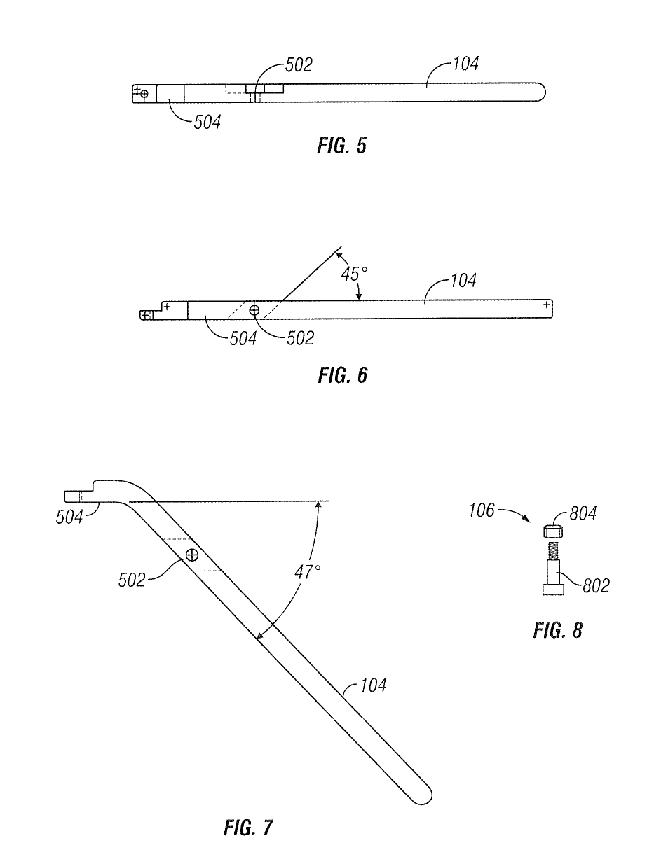

FIG. 5 through FIG. 7 depict the construction of the second handle (104). The second handle (104) is formed in a manner similar to the first handle, with similar machine cuts being made on the jaw (504) and fulcrum point (502). The cuts in both levers at the fulcrum point (502) allow the tool's handle to maintain its approximate overall thickness with both handles assembled. Following the machine cuts, the handle is bent to approximately 47 degrees, approximately 1 to 2 inches from the jaw end (504).

The purpose of the angular bends in both handles is to allow the tool to be used on a rotor while the rotor remains mounted on the hub of the wheel. This bend allows for clearance between the user's knuckles (and/or tool handle) and the wheel rim or spokes. While the preferred embodiment specifies a particular bend angle, one skilled in the art will appreciate that other angles (including compound angles) can be chosen for the handle bends without straying from the scope of the invention. For example, compound angles may be utilized such that one angle provides clearance between the rotor and spokes for the fulcrum area while the additional angle provides clearance from the handle to certain frame members.

FIG. 8 shows construction of the fulcrum bolt (106). The bolt in this embodiment is a steel socket head screw (802) that is appropriately sized for the fulcrum hole (202 and 502) penetrating both levers (102 and 104). One skilled in the art will appreciate that other fasteners (such as rivets, hex head bolts, carriage bolts, and the like) may also be used. The purpose of the fulcrum bolt is to rigidly retain the handles as a pair while still allowing the handles to move, relatively freely, in relation to one another, with minimal side-play.

The bolt shown features a 0.5220 inch shank which is only fractionally larger (i.e., 0.0220 inches) than the overall depth of the fulcrum holes (202 and 502) in combination. Thus, when the nut (804) is applied to the bolt (802), it can be bottomed against the shank without restricting the movement of one lever (102) relative to the other (104). The nut in this embodiment is preferably a locking-type nut to prevent loosening during use. When assembled, the levers should have sufficient side play to allow the levers to move freely relative to one another.

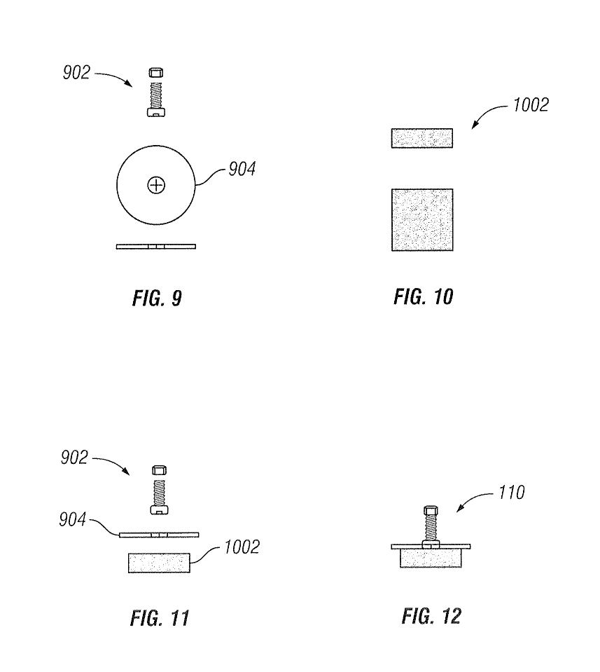

FIG. 9 through FIG. 12 show the elements of a deglazing head (110). Two heads (110) are utilized in the present embodiment. The head (110) consists of a screw (902), a flat washer (904), and an abrasive pad or “stone” (1002). The flat washer (904) serves as a platform upon which the stone (1002) is mounted. In this embodiment, the stone (1002) is mounted upon the washer (904) by an adhesive suitable for bonding the abrasive material to steel. However, other adhesives may be utilized depending upon the flat washer material.

The stone in the present embodiment is approximately 1 inch square by approximately 0.2 to 0.5 inches in thickness. However, other stone shapes and thicknesses may be used. For example, a rounded stone may also be used and may be more aesthetically appealing due to the shape of the washer upon which it is attached. If clearance between the rear of the rotor and the wheel hub is an issue, a thinner stone may be utilized. If clearance is not an issue, a thicker stone may be utilized to extend the life of the deglazing head.

Before the stone (1002) is mounted upon the washer (904), the screw (902) is placed through the washer (904) such that the screw head is on the mounting side of the washer (904). Once the adhesive is applied and the stone (1002) is attached to the washer (904), the screw (902) will be held firmly in place. Another embodiment allows the screw (902) to be welded to the washer (904) with the head of the screw on either side of the washer. Yet another embodiment utilizes a single machined piece of material that duplicates the function of the washer (904) and screw (902) in combination.

After the adhesive is set, the deglazing heads are ready for attachment to the jaw end of the handles. Referring again to FIG. 1, each lever receives at least one deglazing head (110). The screw (902) in conjunction with a locking nut holds the deglazing head in position at the jaw end of the lever (112). When the head (110) is attached to the jaw (112), the lock nut is tightened such that the head (110) floats approximately 2 to 4 degrees relative to the jaw. It is important that at least one head (110) float in order to maintain optimal contact between the abrasive material and an uneven rotor surface.

In yet another embodiment, the head (110) further comprises a compression spring that is compressed between the washer (904) and the jaw (112) as the locking nut is tightened. During tool assembly, the nut is tightened such that the spring is only partially compressed. This allows further freedom for the head (110) to “float” relative to the jaw (112).

The spring strength should be chosen such that appropriate grip pressure on the handles does not cause the springs to bottom out when the heads (110) properly engage a rotor surface. The proper spring compressive strength is that which allows the head (110) to engage the rotor with sufficient surface pressure to cut the glaze while only partially compressing the spring. Use of such springs can prevent over-machining of a rotor surface by providing a means for the user to determine if he or she is gripping the device too excessively (i.e., if the appropriate springs bottom during use, the grip is excessive).

With an aggressive grit on the deglazing head (110), less surface pressure is required between the head and the rotor to cut the glaze. A finer grit on the deglazing head (110) may require greater surface pressure between the head and rotor to cut the glaze. Consequently, an aggressive grit would require a lighter spring pressure relative to a finer grit. However, a spring may also be designed such that the compressive spring pressure increases as the spring is compressed, so that one spring may be used for either type of grit.

Use of the apparatus to deglaze a brake rotor first requires the motorcycle or ATV to be raised such that the wheel upon which the rotor to be deglazed is mounted can be freely rotated. The apparatus is placed over the rotor, near the disc brake caliper, with both deglazing heads contacting the rotor's friction surface. If the device features jaws that close when the handle is squeezed, a small amount of hand grip pressure is applied to the handles of the apparatus to allow the abrasive material to cut into the rotor surface. If not, however, the spring is allowed to maintain sufficient pressure on the handles (and consequently, the jaws) such that the abrasive material may cut into the rotor surface.

Next, the user's free hand is used to grip the tire and rotate the wheel assembly. The wheel is manually rotated, slowly, until an edge of the deglazing heads contact the disc brake rotor. While maintaining slight grip pressure on the handles, the wheel is rotated a sufficient number of times to break through the surface glaze and restore the rotor surface roughness. This typically takes 4 or 5 revolutions of the wheel, but may require additional revolutions or a more aggressive grit to achieve the necessary finish if the rotor is in bad condition. If the finish is relatively smooth to begin with, a less aggressive grit or fewer revolutions may be utilized.

On some brake rotors it is possible to deglaze an area greater than the area covered by the brake pads. This can be accomplished by resting the fulcrum area against the rotor edge and applying an up-and-down or oscillating motion to the handle as the wheel rotates.

Once the desired rotor finish is restored, the apparatus is removed and the vehicle's brake actuator lever is manipulated to restore brake pad contact with the rotor. If adjustments to the actuator lever are required, they should be made at this point. Finally, the vehicle can be ridden or otherwise moved slowly, applying the brakes several times to burnish the rotor and pads. This will restore or improve overall brake feel and action.

Although the invention hereof has been described by way of a preferred embodiment, it will be evident to one skilled in the art that other adaptations and modifications can be employed without departing from the spirit and scope thereof. For example, materials different from those discussed may be chosen to construct the individual components. In addition, alternative embodiments may feature different dimensions, radii, or angles without straying from the inventive concept.

The terms and expressions employed herein have been used as terms of description and not of limitation; and thus, there is no intent of excluding equivalents, but on the contrary it is intended to cover any and all equivalents that may be employed without departing from the spirit and scope of the invention (58,266).

1. A disc brake rotor de glazing tool, the tool comprising:
a pair of opposing levers, each lever comprising a handle end and a jaw end; and
at least two opposing deglazing heads, wherein each deglazing head comprises an abrasive material.

2. The tool of claim 1 wherein the jaw ends converge when grip pressure is applied to the handle ends of both levers.

3. The tool of claim 2 further comprising a compression spring, wherein the opposing handles are held apart by the spring pressure.

4. The tool of claim 2 further comprising at least one compression spring, wherein the at least one spring is partially compressed such that it maintains pressure between at least one of the opposing levers and at least one of the deglazing heads, with sufficient spring pressure to allow the deglazing head to float relative to the plane of the jaw end to which it is attached.

5. The tool of claim 1 further comprising a first compression spring, wherein the jaw ends diverge when grip pressure is applied to the handle ends of both levers, and wherein the first spring pressure causes the deglazing heads to converge when close together with no grip pressure is applied to the handles.

6. The tool of claim 5 further comprising at least one second compression spring, wherein the at least one second spring is partially compressed such that it maintains pressure between at least one of the opposing levers and at least one of the deglazing heads, with sufficient spring pressure to allow the deglazing head to float relative to the plane of the jaw end to which it is attached.

7. The tool of claim 2 or claim 5 wherein the handles are angled to provide clearance between the handles and wheel when the heads are engaged with the disc brake rotor.

8. The tool of claim 2 or claim 5 wherein the abrasive material is selected from the group consisting of aluminum oxide, silicon carbide, boron carbide, or carbon.

9. The tool of claim 2 or claim 5 wherein the abrasive material has a grit of from approximately 30 to approximately 80.

10. The tool of claim 2 or claim 5 wherein at least one of the at least two deglazing heads floats relative to the plane of the jaw end to which it is attached.

11. A method for deglazing a disc brake rotor, the method comprising:
(a) selecting a handheld tool with opposing abrasive pads of sufficient grit to reduce the surface glaze or obtain the desired surface finish on the rotor;
(b) placing the tool over the disc brake rotor such that the abrasive pads contact both friction surfaces of the rotor;
(c) rotating the wheel to which the disc brake rotor is attached;
(d) applying sufficient grip pressure to the handles of the handheld tool to allow the abrasive material to cut into the rotor surface without completely stopping the wheel′s rotation;
(e) rotating the wheel a sufficient number of revolutions to reduce the surface glaze or obtain the desired surface finish; and
(f) removing the tool and operating the brake to burnish the rotor and pads.

12. The method of claim 11, the method further comprising:
(d)(1) applying an oscillating movement to the tool to allow the pads to travel beyond the rotor area that is covered by the disc brake pads.
